(19) United States
(12) Patent Application Publication
(10) Pub. No.: US 2010/0065538 A1
(43) Pub. Date: Mar. 18, 2010

(54) Method and Device for the Fracture Separation of Workpieces

(75) Inventors: Wolfgang Burkhardt, Ansbach (DE); Wemer Kaufhold, Eckental (DE); Stefan Schmidt, Numberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN Nutzfahrzeuge AG, Muenchen (DE)

(21) Appl. No.: 12/562,513

(22) Filed: Sep. 18, 2009

(30) Foreign Application Priority Data
Sep. 18, 2008 (DE) 10 2008 047 688.9

(51) Int. Cl. B23K 26/38

(52) U.S. Cl. 219/121.72; 219/121.67

(57) ABSTRACT

A method and device for fracture separation of a workpiece into components of the workpiece, wherein a recess is produced by a material processing device in a predetermined area of the components by removal of material from the components. The recess serves as a crack initiation site for the separation of the components. The component is heated in an area of the recess by the material processing device, and the heating takes place with a predetermined heat input in such a way that a temperature of the components does not exceed a predetermined temperature.

### BACKGROUND OF THE INVENTION

1. Field of the Invention

The present invention relates to a method and device for fracture separation of components. More specifically, the invention is used for fracture separation of components such as connecting rods or crankshaft housings of internal combustion engines, but it should be pointed out that the method can also be used for other components, e.g., bearing components. For reasons related to cost, bearings of components such as connecting rods or crankshaft housings are produced increasingly today by the so-called “cracking” technique. In this method, a one-piece bearing is fabricated, and after a notch or crack-initiation point has been introduced, a suitable method is used to break the bearing apart to arrive at a desired constructed shape.

2. Description of the Related Art

DE 43 03 592 A1 describes a method for the production of a component with at least one split bearing seat. A bearing cover is separated from a shaped part, wherein a bearing layer of a material different from that of the shaped part is applied to a bearing seating surface of the shaped part, and then the bearing layer is split by fracture-induced separation. This document also describes that the area of the shaped part where the separation point is located is made brittle by a targeted heat treatment. As a result of this procedure, however, it is not possible to obtain a precise fracture site under all conditions.

DE 43 06 280 A1 describes a method for the production of a component with a split contact surface for rolling elements. Here, too, a method of fracture separation is used to produce the component, wherein an edge layer is hardened before the fracture separation. According to this method, a suitable crack-initiating notch is introduced in particular by mechanical processing or by the use of an appropriately designed die set.

DE 690 03 362 T2 describes a method for splitting bearing parts by the introduction of hydrogen. At least one area of a wall adjacent to a crack is exposed to a source of hydrogen so that this hydrogen dissolves into the metal. This has the effect of promoting the growth of a crack at this location. In this method, chemicals are used to bring about the fracture separation. The method is therefore relatively expensive.

EP 1 225 348 A2 describes a method for the preparation of a fracture separation site. A brittle zone is formed locally in an area intended for crack initiation. Using a high-energy beam directed at the area in question, the material of a first zone and the material of an adjacent second zone are caused to diffuse locally into each other. Near the fracture separation site, comparatively large elastic deformations are allowed. For this process, it is necessary to introduce comparatively large amounts of energy. In addition, the method is suitable only for components made of composite materials. Depressions resembling blind holes are formed in the area of the crack initiation zone.

A method for the production of a multi-part metal component is known from U.S. Pat. No. 5,208,979, according to which a laser is used to produce a crack initiation site. The laser, however, is used only to remove material.

DE 100 22 884 A1 describes a method for fracture separation of components, wherein, in an area where the fracture-induced separation is to occur, a locally limited heat treatment is carried out to increase the brittleness of this area versus the untreated component. In particular, the heat treatment is carried out by melting; that is, the material is partially or completely melted, and embrittling elements or compounds in solid, liquid, or gaseous form are incorporated into the melt. In this way, areas of increased hardness and thus of internal compressive stress are produced in the area of a notch, areas which are opposed by tensile stresses in the remaining part of the component.

DE 197 52 753 A1 describes a method for fracture separation of a bearing cover for a connecting rod, Blind hole-like depressions, starting from the surface of the component and separated by webs of reduced cross section, are produced by melting, vaporizing, and/or air-blasting certain sections of the component on one side of the fracture separation plane. In this method material is removed in a highly directed way, as a result of which this method turns out to be relatively complicated.

DE 42 04 948 C2 describes a method for the production of sintered components. The component is press-molded out of powder, sintered, and cooled. The component is provided during the press-molding operation with at least one separation notch in the area where the two individual parts are to be separated from each other. No measures are intended or planned for providing any further heating process when the separation notch itself is produced.

DE 196 17 402 A1 describes a method for forming a crack-initiation point for the fracture separation of a component. In this method, radiation energy is introduced by a laser, wherein the production of the notch and the introduction of the radiation energy take place in different process steps.

### SUMMARY OF THE INVENTION

The present invention is based on providing a method for fracture separation of components which is simpler than the methods known from the prior art. In addition, a “cracking process” is to be promoted such that, especially in the area of a crack-initiation site or notch, internal tensile stresses are generated in a targeted manner to support crack propagation.

In an inventive method for the fracture separation of a workpiece into components of the workpiece, a recess is produced in a predetermined area of the workpiece by a material processing device, which removes material from the workpiece. The recess serves as a crack initiation site for the separation of the workpiece. According to one embodiment of the invention, the workpiece is heated in an area of the recess by the material processing device, and the heating is carried out with a predetermined heat input in a targeted manner such that a temperature of the component does not exceed a predetermined temperature.

In a preferred embodiment, the same material processing device is used both to remove the material and to heat the component. In addition, in contrast to methods known from the prior art, the amounts of thermal energy introduced are not relatively arbitrary; on the contrary, the energy input is precisely controlled, wherein the heating causes a targeted increase of the hardness of the material.

To effectively remove the material, it is possible to introduce large amounts of energy at specific points and in highly focused fashion. The associated increase in the temperature of the resulting contour can lead, as a side effect, to a hardness increase of the surface of the notch—a phenomenon which the invention exploits. The hardness increase is expressed in part by microscopic heat-treatment cracks and is based on a transformation of the microstructure of the metal material. In principle, it is possible to use two different processing units such as two different lasers to provide the same heat input. In particular, however, the energy input will be controlled in such a way or the temperature of the component will be limited in such a way in every case that the material is subjected only to local annealing. This annealing relieves the internal compressive stress. The annealing of the material preferably takes place only in the area of said crack initiation site. The goal is to support the cracking process by producing internal tensile stresses in a targeted manner in the area of the recess to support crack propagation.

The material processing device may include a laser device. Alternatively, it is also possible to produce the previously mentioned crack initiation site by a machining process. However, the use of a laser offers the advantage that a local, precisely limited heat input can be accomplished at the same time. The laser removes a specific amount of material and thus creates the desired geometry, namely, a recess in this case.

The technology and equipment described above for the focus introduction of energy by means of a laser are used primarily to achieve the targeted transformation of the material in the area of the crack initiation site or notch. Through the input of a calculated amount of energy and the resulting deliberate hardness increase, it is possible to achieve additional internal compressive stresses in this area in a targeted manner or to increase those already present. For equilibrium reasons, tensile stresses in the remaining part of the component oppose these areas of compressive stress.

The heating of the components is preferably carried out such that only the environment of the recess or crack initiation site is heated. In this way, it is possible in particular to achieve precise separation during the following separation process.

The heating is preferably carried out in such a way that an annealing of the material occurs only in a predetermined area of the recess. In this way, internal compressive stresses in the notch are relieved and/or tensile stresses are built up to exert a positive influence on the initiation of the fracture. No annealing occurs in the other areas of the material. An annealing of the material preferably occurs at the surface of the material in the area of the recess and extends down to a predetermined depth of the component.

The workpiece is preferably a bearing device such as a connecting rod, but this is not the only possibility. After fracture separation, the two components thus obtained together form this bearing device.

In another advantageous method, at least one characteristic property of the material processing device is controlled such that the temperature of the components does not exceed the predetermined temperature. Thus preferably the component temperature is limited so that only a local annealing of the material takes place. The predetermined temperature in question is preferably the annealing temperature of the material. The characteristic property of the material processing device is preferably a property which is selected from a group of properties including laser power output, laser intensity, pulse duration, irradiation time, wavelength, focusing, beam cross section, combinations of these, and other like properties of the material processing device known or hereafter developed that control the energy input into the component. As a result of these properties or combinations of them, it is possible in an especially advantageous manner to control the energy input into the component in question.

The characteristic property of the material processing device is preferably controlled also as a function of a geometric shape of the components or of the workpiece. Thus it is also possible to adapt the energy input to components of smaller dimensions.

Through a favorable selection of the properties or parameters, and especially through the selection of these properties as a function of the geometry of the component, internal stresses produced in the recess which have a favorable effect on the cracking process; namely, they reduce the cracking forces and limit the range of variation of the crack surface geometry.

It is advantageous to produce a continuous recess in the workpiece or component instead of a plurality of blind holes as known from some of the prior arts. It is especially preferred to produce exactly one such recess. In this way, the heat input can be controlled more effectively than is possible in the case of a plurality of recesses separated from each other.

It is advantageous for this recess to extend over the entire thickness of the components, as a result of which the following process of fracture separation is improved.

The present invention is also aimed at a device for the fracture separation of a workpiece into components, wherein the device comprises a material processing device, which acts on the components in such a way as to remove material from the components or from the workpiece in order to produce a recess serving as a crack-initiation site in the area of this removed material, wherein the material processing device emits radiation, which heats the components in an area of this recess during processing.

According to the invention, the device comprises a control unit, which heats the components in the area of the recess in such a way that a temperature of the components does not exceed a predetermined temperature. The material processing device is preferably a laser, wherein the radiation intensity to be applied by this laser to the workpiece can be controlled and in particular an upper limit can be set to the radiation intensity.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1a is a cross section of a notch known from the prior art;

FIG. 1b is a graph illustrating the stress relationships in the prior art;

FIG. 2a is a graph showing a crossection of an inventive notch;

FIG. 2b is a stress distribution curve of the inventive method; and

FIG. 3 is another crossection of an inventive notch.

### DETAILED DESCRIPTION OF THE PRESENTLY PREFERRED EMBODIMENTS

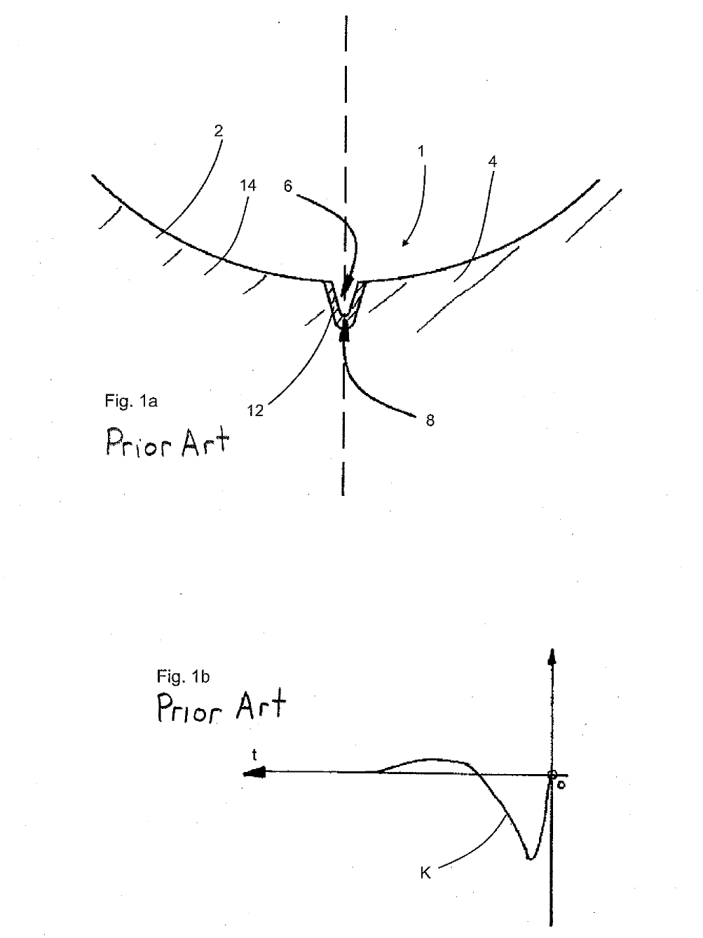

FIG. 1a shows a schematic diagram of part of a component or workpiece 1, such as a connecting rod. This workpiece 1 comprises here two components 2 and 4, which are to be separated from each other. More precisely, the workpiece is to be separated by the fracture separation method into the two components 2, 4, preferably along the dotted line.

A recess 6 serves as a crack initiation site for the following separation of the components. This recess comprises a recess 6 base or groove base 8 and an area 12, which is created during the process by which the recess 6 is formed.

FIG. 1a thus shows a cross section of a bore with said recess or cracking notch, wherein the input of heat creates a quenched area with internal compressive stress in the area marked 12, especially in the area 8. This hardness increase is based on the transformation of the microstructure, wherein the microstructure of the heat quenched area 12 is distorted in tetragonal fashion or martensite structure, and occupies a larger amount of space than the remaining area 14, which is not heat quenched and comprises a cubic space-centered microstructure. As a result of these different spatial dimensions, stresses are produced in the component, which lead in turn to internal compressive stresses at the surface of the locally hardened area.

FIG. 1b shows schematically the plot of stress distribution K versus depth t of the component. It can be seen that, at the surface, a comparatively high level of internal compressive stress σ is present. As said above, corresponding internal tensile stresses are present at greater depth in the component to oppose these internal compressive stresses.

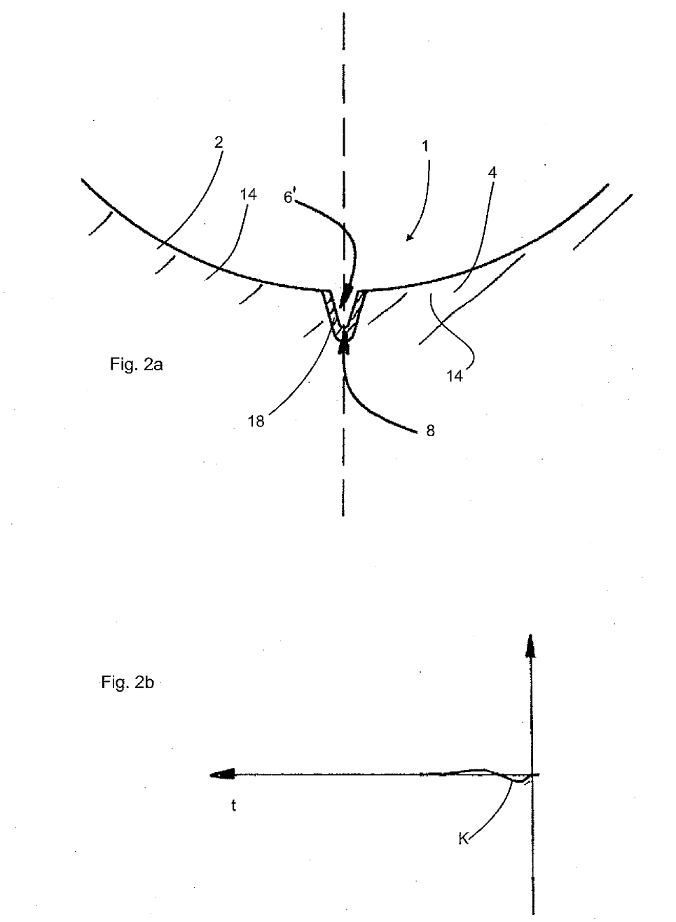

FIG. 2a shows a diagram illustrating the inventive method. Here we see the area of a laser notch after an inventive stress-relief treatment. The area designated here by the number 18 corresponds to the internal stress distribution curve at the base of the notch described in FIG. 2b. Near the surface, the internal compressive stress induced by the laser notch are almost completely relieved.

In contrast to the hardness increase in FIG. 1a, in the area 18 a heating to the annealing temperature of the material and preferably also a controlled slow cooling occurs. An annealing process therefore occurs at the surface of the notch. In this annealing process, carbon (C) is segregated, and the tetragonal distortion of the resulting martensite microstructure is reduced. In this way, the dislocations are decreased, and the internal compressive stress is reduced. In a preferred embodiment, the internal tensile stresses are also reduced. Thus, as a result of the inventive method, a targeted annealing of the base material is achieved, and the internal compressive stresses in the recesses 6′ are reduced.

Processing is preferably carried out such that the cross section of the recess 6′ remains essentially constant over the component thickness. Recess 6′ is preferably perpendicular to the plane of the figure. In this way, it is possible to control the heat input more effectively.

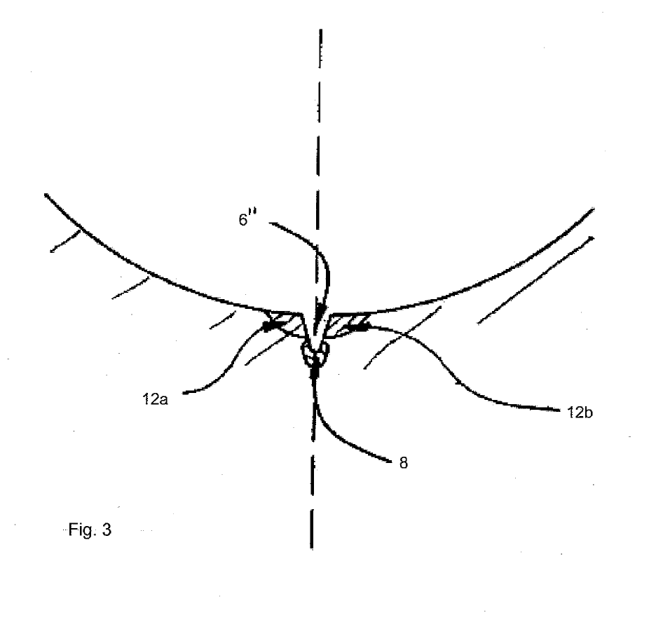

FIG. 3 is another diagram of an inventive method. Here the heat treatment was such that only a partial relief of the internal stresses occurs. Two areas 12a and 12b thus are formed at the edges of the notch 6″, that comprise the internal compressive stress induced by the laser notching. Only at the base 8 of the groove or notch 6″ is the internal compressive stress relieved by the described method. The desired advantages is achieved with this method because the base 8 of the notch 6″, i.e., the microstructure at the base of the notch, is what is important to the following separation process. In other words, it is typically to treat one area of the recess in the manner described here.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A method for fracture separation of a workpiece into components of the workpiece, the method comprising:
removing material from the workpiece to form a recess in the workpiece in a predetermined area of the components, the recess configured as a crack initiation site for the fracture separation of the components; and
heating the workpiece in an area of the recess with a predetermined heat input such that a temperature of the components does not exceed a predetermined temperature.

2. The method according to claim 1, wherein at least one of the removing material from the workpiece and the heating the workpiece is performed using a laser device.

3. The method according to claim 1, wherein the heating is performed such that the components are heated only in the area of the recess.

4. The method according to claim 3, wherein the heating further comprises annealing a material of the workpiece in a predetermined area of the recess.

5. The method according to claim 1, wherein the workpiece is a bearing device.

6. The method according to claim 2, wherein at least one characteristic property of the laser device is controlled such that the temperature of the components does not exceed the predetermined temperature.

7. The method according to claim 6, wherein the characteristic property of the laser device is selected from a group consisting of laser power output, laser intensity, pulse duration, irradiation time, wavelength, focusing, and combinations thereof.

8. The method according to claim 6, wherein the characteristic property of the material processing device is controlled based at least in part on a geometric shape of the components.

9. The method according to claim 1, wherein a continuous recess is formed in the workpiece.

10. The method according to claim 6, wherein the recess extends over an entire thickness of the workpiece.

11. The method according to claim 1, wherein the removing material from the workpiece are both performed using a laser device.

12. The method according to claim 11, wherein at least one characteristic property of the laser device is controlled such that the temperature of the components does not exceed the predetermined temperature.

13. The method according to claim 12, wherein the characteristic property of the laser device is selected from a group consisting of laser power output, laser intensity, pulse duration, irradiation time, wavelength, focusing, and combinations thereof.

14. The method according to claim 12, wherein the characteristic property of the material processing device is controlled based at least in part on a geometric shape of the components.

15. A device for the fracture separation of a workpiece into components, the device comprising:
a material processing device configured to act on the components to remove material from the components to produce a recess configured as a crack initiation site in the area of the removed material,
the material processing device configured to emit radiation that heats the components in an area of this recess during processing; and
a control unit configured to control the heating of the component in the area of the recess such that a temperature of the components does not exceed a predetermined temperature.

16. The device according to claim 1, wherein the material processing device is a laser.
